(19) United States
(12) Patent Application Publication
(10) Pub. No.: US 2024/0144079 A1
(43) Pub. Date: May 2, 2024

(54) SYSTEMS AND METHODS FOR DIGITAL IMAGE ANALYSIS

(71) Applicant: Capital One Services, LLC, McLean, VA (US)

(72) Inventors: Joshua Edwards, Carrollton, TX (US); Tyler Maiman, MELVILLE, NY (US); Samuel Yip, East Brunswick, NJ (US); Bryant Yee, Silver Spring, MD (US); Haytham Yaghi, Oakton, VA (US)

(21) Appl. No.: 17/979,147

(22) Filed: Nov. 2, 2022

(51) Int. Cl. G06N 20/00

(52) U.S. Cl. CPC G06N 20/00

(57) ABSTRACT

Disclosed embodiments may include a system configured to perform digital image analysis. The system may receive transaction data and image data associated with a user. The system may identify, from the transaction data, first travel feature(s). The system may identify, from the image data via computer vision, second travel feature(s). The system may train a machine learning model (MLM) to generate trip recommendation(s) for the user based on the first travel feature(s) and the second travel feature(s). The system may determine, via the trained MLM, whether at least a first trip recommendation of the trip recommendation(s) exceeds a predetermined threshold indicating a likelihood the user will be interested in the first trip recommendation. Responsive to determining the first trip recommendation exceeds the predetermined threshold, the system may provide the first trip recommendation to the user.

The disclosed technology relates to systems and methods for digital image analysis. Specifically, this disclosed technology relates to correlating image and user data to improve digital image analysis techniques.

### BACKGROUND

Traditional image analysis techniques typically focus on identifying locations or items within images. These techniques may provide objective or factual information pertaining to analyzed images, however, are typically limited in terms of gleaning personal or subjective information specific to individual users associated with the images.

Accordingly, there is a need for improved systems and methods for digital image analysis. Embodiments of the present disclosure may be directed to this and other considerations.

### SUMMARY

Disclosed embodiments may include a system for digital image analysis. The system may include one or more processors, and memory in communication with the one or more processors and storing instructions that, when executed by the one or more processors, are configured to cause the system to perform digital image analysis. The system may receive transaction data and image data associated with a user. The system may identify, from the transaction data, one or more first travel features. The system may identify, from the image data via computer vision, one or more second travel features. The system may train a machine learning model (MLM) to generate one or more trip recommendations for the user based on the one or more first travel features and the one or more second travel features. The system may determine, via the trained MLM, whether at least a first trip recommendation of the one or more trip recommendations exceeds a predetermined threshold indicating a likelihood the user will be interested in the first trip recommendation. Responsive to determining the first trip recommendation exceeds the predetermined threshold, the system may provide the first trip recommendation to the user.

Disclosed embodiments may include a system for digital image analysis. The system may include one or more processors, and memory in communication with the one or more processors and storing instructions that, when executed by the one or more processors, are configured to cause the system to perform digital image analysis. The system may receive image data associated with a user. The system may identify, from the image data via computer vision, one or more travel features. The system may train an MLM to generate one or more trip recommendations for the user based on the one or more travel features and using a facial emotion recognition technology (FER). The system may determine, via the trained MLM, whether at least a first trip recommendation of the one or more trip recommendations exceeds a predetermined threshold indicating a likelihood the user will be interested in the first trip recommendation. Responsive to determining the first trip recommendation exceeds the predetermined threshold, the system may provide the first trip recommendation to the user.

Disclosed embodiments may include a system for digital image analysis. The system may include one or more processors, and memory in communication with the one or more processors and storing instructions that, when executed by the one or more processors, are configured to cause the system to perform digital image analysis. The system may receive image data associated with a user. The system may identify, from the image data via computer vision, one or more travel features. The system may train an MLM to generate one or more trip recommendations for the user based on the one or more travel features. The system may determine, via the trained MLM, whether at least a first trip recommendation of the one or more trip recommendations exceeds a predetermined threshold indicating a likelihood the user will be interested in the first trip recommendation. Responsive to determining the first trip recommendation exceeds the predetermined threshold, the system may provide the first trip recommendation to the user.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for performing digital image analysis in accordance with certain embodiments of the disclosed technology.

FIG. 2 is block diagram of an example recommendation generation system used to generate recommendations based on digital image analysis, according to an example implementation of the disclosed technology.

FIG. 3 is block diagram of an example system that may be used to perform digital image analysis, according to an example implementation of the disclosed technology.

### DETAILED DESCRIPTION

Traditional image analysis techniques typically focus on identifying locations or items within images; however, are not configured to derive a method or class of travel or type of experience from those items, much less determine whether a user associated with an image viewed the photographed experience as being a positive or negative one. As such, disclosed embodiments may provide more accurate image analysis results by employing user data, e.g., user interaction data, user transaction data, etc., and correlating it with the images to more accurately provide insights on MLM-driven digital image analysis techniques.

Accordingly, examples of the present disclosure may provide for receiving image data associated with a user, using computer vision to identify features associated with a user's travels from the image data, and training an MLM, for example by using FER (facial emotion recognition technology), to generate trip recommendations for the user based on the identified features. Examples of the present disclosure may also provide for receiving transaction data associated with a user, identifying features associated with a user's travels from the transaction data, and training an MLM to generate trip recommendations for the user based on the identified features.

Disclosed embodiments may employ machine learning models (MLMs), among other computerized techniques, to generate a trip recommendation for a user. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to generate trip recommendations based on image and/or transaction data associated with a user. This, in some examples, may involve using user-specific image and/or transaction input data and an MLM, applied to generate a trip recommendation for a specific user. Using an MLM and a computer system configured in this way may allow the system to provide a user with a customized trip recommendation.

This is a clear advantage and improvement over prior technologies that may not provide a trip recommendation as customized or tailored to a specific user. The present disclosure solves this problem by taking a variety of user-specific factors into consideration (e.g., image data, social media data, transaction data, etc.) when generating a trip recommendation. Furthermore, examples of the present disclosure may also improve the speed with which computers can generate such recommendations. Overall, the systems and methods disclosed have significant practical applications in the digital image analysis and travel planning fields because of the noteworthy improvements of the customization of generated recommendations, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

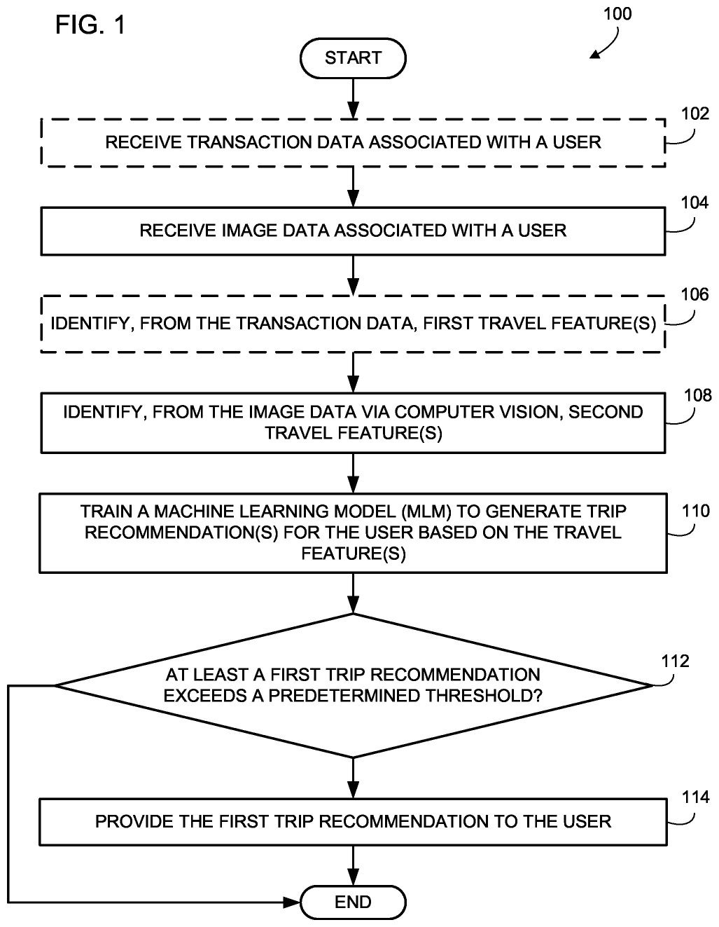

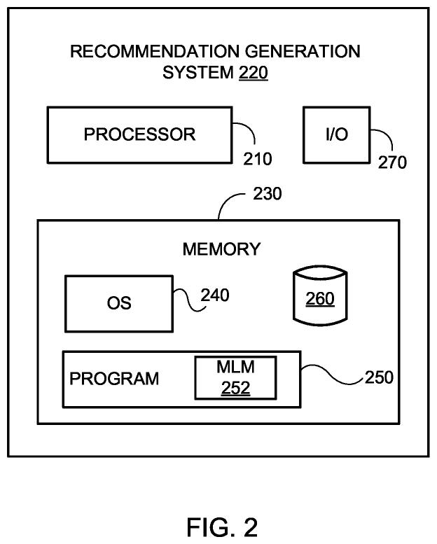

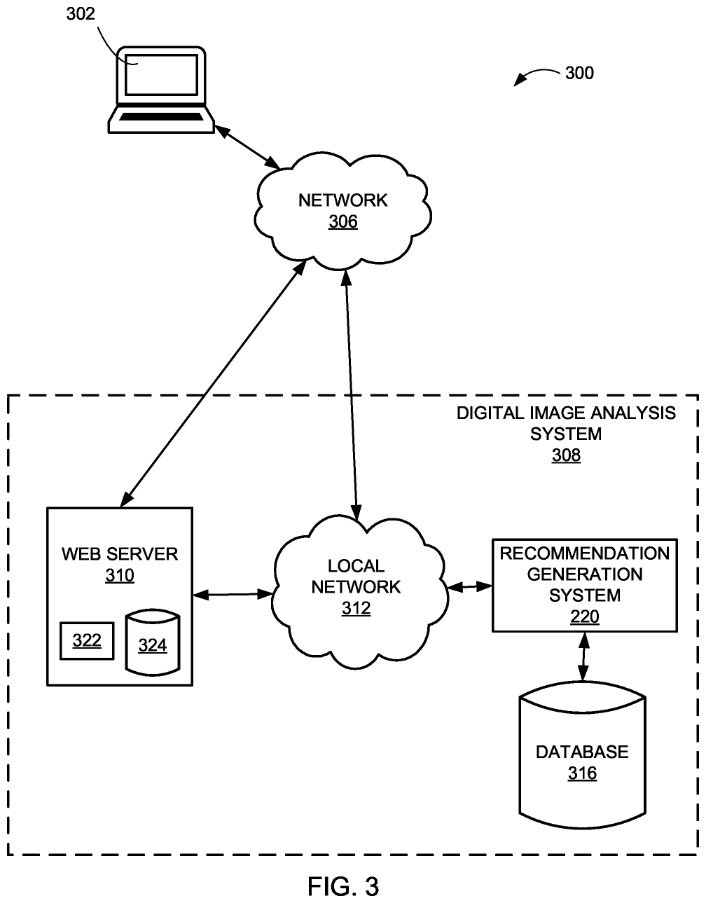

FIG. 1 is a flow diagram illustrating an exemplary method 100 for performing digital image analysis, in accordance with certain embodiments of the disclosed technology. The steps of method 100 may be performed by one or more components of the system 300 (e.g., recommendation generation system 220 or web server 310 of digital image analysis system 308, or user device 302), as described in more detail with respect to FIGS. 2 and 3.

In optional block 102, the recommendation generation system 220 may receive transaction data associated with a user. In some embodiments, recommendation generation system 220 may be owned and/or operated by an organization (e.g., a financial institution) that collects, compiles, tracks, etc. transaction data associated with the organization's customers. In some embodiments, the system may be configured to receive transaction data, and to identify various transactions a user has previously conducted, the transactions being indicative of the user's travel experiences based on, for example, a merchant identifier (e.g., a merchant category code (MCC)), a transaction date, a transaction time, and/or a transaction location.

In block 104, the recommendation generation system 220 may receive image data associated with the user. In some embodiments, the system may be configured to receive image data from local storage (e.g., stored on the user's mobile device) and/or cloud storage. In some embodiments, the system may be configured to receive image data from a social media account. For example, the user may have a system account that the user previously linked to the user's social media account, such that the system may be configured to track photos involved in social networking activity. For example, the system may be configured to identify photos the user has posted to his/her own social media account, and/or photos other social media account users have posted that are associated with the user (e.g., if another social media account user posted a photo, and tagged or otherwise associated the photo with the user, or if another social media account user posted a photo that the user subsequently “liked” or on which the user commented).

In some embodiments, the user may have previously provided the system with access to certain types of photos, for example, based on one or more permissions. For example, the user may have specified that the system may access photos taken within certain time periods, photos posted to certain public websites, photos that were involved in certain social networking activity (e.g., only those photos the user posted to his/her own profile), and the like.

In some embodiments, the system may be configured to utilize image analytics to evaluate the various individuals in each photo. For example, the system may be configured to determine a relationship of members within the photos, such as a friend, spouse, child, etc., of the user. The system may make this type of determination based on, for example, data taken from information contained in a profile associated with the user (e.g., a travel portal). The system may be configured to use these determinations to provide the user with customized travel recommendations, as discussed herein, based on people with whom the user may tend to travel (e.g., destinations and/or activities that may be of interest to the user when traveling with certain other individuals).

In some embodiments where the system is configured to receive transaction data, as discussed above (block 102), the system may be further configured to determine which individual within a group photo(s), such as the user or a family member of the user, is typically a trip organizer. This determination may be made, for example, by evaluating which individual tends to conduct the most transactions surrounding an upcoming trip. The system may be configured to provide customized travel recommendations, as discussed herein, that are more tailored to a trip organizer (and/or a main purchaser) of a group of individuals.

In some embodiments, the system may receive additional data associated with a user, such as browsing/search history, cookies, etc., such that the system may provide the user with customized travel recommendations, as discussed herein. A benefit of evaluating this type of user data is that the system may provide a user with real-time travel recommendations based on a user's current behavior or interests.

In optional block 106, the recommendation generation system 220 may identify, from the transaction data, one or more first travel features. In some embodiments, the one or more first travel features may include a merchant identifier, a location, a date, a transaction amount, a reservation booking, rental information, and/or insurance information. For example, the system may be configured to identify one or more transactions indicating a user's lodging preferences, e.g., if the user paid for a hotel, short-term rental, campground, bed and breakfast, etc. As another example, the system may identify one or more transactions indicating a user's travel activity preferences, e.g., if the user paid for a museum ticket, a theater show ticket, snorkeling gear, a boat trip, a dinner reservation, etc. By identifying such features from the transaction data, the system may be configured to analyze the types of places, activities, price ranges, etc., associated with a user's previous travel experiences in order to generate a custom travel recommendation for the user, as further discussed herein.

In block 108, the recommendation generation system 220 may identify, from the image data via computer vision, one or more second travel features. In some embodiments, the computer vision techniques utilized may include, for example, image classification, object detection, semantic segmentation, instance segmentation, panoptic segmentation, keypoint detection, person segmentation, depth perception, image captioning, scene reconstruction, event detection, video tracking, object recognition, 3D pose estimation, 3D object reconstruction, learning, indexing, motion estimation, visual servoing, 3D scene modeling, and/or image restoration. Depending on the one or more computer vision techniques used, the system may be configured to, for example, classify or categorize the types of items or objects in an image (e.g., food, buildings, people), separate people and/or detect certain poses people have in an image, detect the depth of various items or people in an image, and the like. For example, the system may be configured to utilize one or more computer vision techniques to evaluate a photo of a family visiting the Grand Canyon. The system may be configured to predict which people in the photo correspond to the user and the user's family members based on the physical separation between the user and other people in the photos (e.g., whether certain people are directly next to the user, whether other people are in the background of the image, etc.). The system may be further configured to evaluate the scope of the objects in the image (e.g., a picture of the canyon behind the family) based on depth perception and relative scale. The system may be further configured to evaluate the poses and/or facial expressions of the user and user's family in the image to aid in determining a likelihood the user and family had a positive or negative experience when on this particular trip, as further discussed herein.

In some embodiments, the one or more second travel features may include a location, an object, a building, a landscape, a person, an animal, a frequency of an image, a size of an image, and/or a scale of an image. For example, the system may utilize computer vision technology configured to analyze photos associated with the user, as discussed above, to identify any such features that may aid in generating a customized travel recommendation for the user, as discussed herein. For example, identifying a location may indicate the types of places the user prefers to visit, identifying an animal may indicate subject matter interest, etc.

In block 110, the recommendation generation system 220 may train an MLM to generate one or more trip recommendations for the user based on the one or more first travel features and/or the one or more second travel features. A trip recommendation may include, for example, a travel destination (e.g., a country, city, state, etc.), types of places and/or specific places to stay (e.g., a specific hotel, a campsite, a neighborhood, etc.), activities or excursions (e.g., snorkeling, sightseeing, hiking, visiting a particular museum, etc.), and/or landmarks or landscapes to visit (e.g., the Grand Canyon, the Eiffel Tower, etc.). In some embodiments, the system may be configured to use a first MLM to tag different groupings of photos as corresponding to different types or themes of trips. For example, the first MLM may be configured to take in image data corresponding to the user and tag images as belonging to the user's travels associated with, e.g., camping, hiking, site-seeing, food, etc. In some embodiments, the system may be configured to use a second MLM to input the tagged images from the first MLM, to predict what type of trip a user may likely be interested in taking in the future.

In some embodiments, the system may train an MLM to rank the first travel feature(s) and/or the second travel feature(s) based on which features may more heavily impact a likelihood that a user will be interested in a trip recommendation. For example, the MLM may weight a frequency of an image differently based on a scale of that image. For example, if a user took a certain percentage more photos of one building or landscape versus others, this feature alone may indicate the user's heightened interest in that particular building or object. However, if that building or landscape is of significant scale, for example, the Statue of Liberty, or the Eiffel Tower, the weight of the number of photos of such item may be offset by the item's scale in determining a user's travel preferences.

In some embodiments, the system may train an MLM to make additional recommendations to a user based on a specific travel location recommendation. For example, the system may be configured to access various travel reservation platforms (e.g., Airbnb®, Expedia®, etc.) to evaluate the types of amenities (e.g., a pool, gym, restaurant, etc.) that may be available to a user at a given travel destination.

In some embodiments, the system may train an MLM using FER technology. For example, the MLM may be trained to input image data (e.g., photos) to evaluate a likelihood that the user enjoyed a specific trip, experience, activity, etc., based on the user's facial expression, the facial expression of any other persons in the photos, and/or sentiments or emotions that may be gleaned from the facial expression(s).

In block 112, the recommendation generation system 220 may determine, via the trained MLM, whether at least a first trip recommendation of the one or more trip recommendations exceeds a predetermined threshold indicating a likelihood the user will be interested in the first trip recommendation. In some embodiments, the predetermined threshold may be a fraction on a scale of 0 to 1, or may be a score on a scale of 1 to 100. For example, the system may be configured to predict whether a user is at least 75% likely (e.g., satisfying a score of at least 75 on a 1-100 scale) to be interested in a trip recommendation by evaluating user data (e.g., image data, transaction data, etc.), as discussed herein, to analyze general and specific trips the user has historically taken.

In some embodiments, the predetermined threshold may be a threshold selected by the system (e.g., as a default threshold), or by the user (e.g., previously provided by the user via user account preferences). In some embodiments, the system may be configured to dynamically modify a customized threshold for a specific user. For example, as the system provides a user with travel recommendations, as discussed below, the system may be configured to track which recommendations the user selects (e.g., which trips the user actually ends up taking), such as through the receipt of additional transaction and/or image data, such that the system may continuously update the threshold applicable to that user. A benefit of this feature is that over time, the MLM may improve in providing a user with recommendations of trips that the user may prefer.

In block 114, responsive to determining the first trip recommendation exceeds the predetermined threshold, the recommendation generation system 220 may provide the first trip recommendation to the user. In some embodiments, the system may provide the first trip recommendation to the user via a notification, such as via a pop-up notification in an application, a push notification, an SMS message, an email, and the like.

FIG. 2 is a block diagram of an example recommendation generation system 220 used to generate recommendations based on digital image analysis according to an example implementation of the disclosed technology. According to some embodiments, the user device 302 and web server 310, as depicted in FIG. 3 and described below, may have a similar structure and components that are similar to those described with respect to recommendation generation system 220 shown in FIG. 2. As shown, the recommendation generation system 220 may include a processor 210, an input/output (I/O) device 270, a memory 230 containing an operating system (OS) 240 and a program 250. In some embodiments, program 250 may include an MLM 252 that may be trained, for example, to generate customized trip recommendations. In certain implementations, MLM 252 may issue commands in response to processing an event, in accordance with a model that may be continuously or intermittently updated. Moreover, processor 210 may execute one or more programs (such as via a rules-based platform or the trained MLM 252), that, when executed, perform functions related to disclosed embodiments.

In certain example implementations, the recommendation generation system 220 may be a single server or may be configured as a distributed computer system including multiple servers or computers that interoperate to perform one or more of the processes and functionalities associated with the disclosed embodiments. In some embodiments recommendation generation system 220 may be one or more servers from a serverless or scaling server system. In some embodiments, the recommendation generation system 220 may further include a peripheral interface, a transceiver, a mobile network interface in communication with the processor 210, a bus configured to facilitate communication between the various components of the recommendation generation system 220, and a power source configured to power one or more components of the recommendation generation system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the recommendation generation system 220 may include one or more storage devices configured to store information used by the processor 210 (or other components) to perform certain functions related to the disclosed embodiments. In one example, the recommendation generation system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The recommendation generation system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the recommendation generation system 220 may include the memory 230 that may include one or more programs 250 to perform one or more functions of the disclosed embodiments. For example, in some embodiments, the recommendation generation system 220 may additionally manage dialogue and/or other interactions with the customer via a program 250.

The processor 210 may execute one or more programs 250 located remotely from the recommendation generation system 220. For example, the recommendation generation system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a fraud detection system database 260 for storing related data to enable the recommendation generation system 220 to perform one or more of the processes and functionalities associated with the disclosed embodiments.

The recommendation generation system database 260 may include stored data relating to status data (e.g., average session duration data, location data, idle time between sessions, and/or average idle time between sessions) and historical status data. According to some embodiments, the functions provided by the recommendation generation system database 260 may also be provided by a database that is external to the recommendation generation system 220, such as the database 316 as shown in FIG. 3.

The recommendation generation system 220 may also be communicatively connected to one or more memory devices (e.g., databases) locally or through a network. The remote memory devices may be configured to store information and may be accessed and/or managed by the recommendation generation system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The recommendation generation system 220 may also include one or more I/O devices 270 that may comprise one or more interfaces for receiving signals or input from devices and providing signals or output to one or more devices that allow data to be received and/or transmitted by the recommendation generation system 220. For example, the recommendation generation system 220 may include interface components, which may provide interfaces to one or more input devices, such as one or more keyboards, mouse devices, touch screens, track pads, trackballs, scroll wheels, digital cameras, microphones, sensors, and the like, that enable the recommendation generation system 220 to receive data from a user (such as, for example, via the user device 302).

In examples of the disclosed technology, the recommendation generation system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The recommendation generation system 220 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LS™) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The recommendation generation system 220 may be configured to adjust model parameters during training. Model parameters may include weights, coefficients, offsets, or the like. Training may be supervised or unsupervised.

The recommendation generation system 220 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The recommendation generation system 220 may be configured to optimize statistical models using known optimization techniques.

Furthermore, the recommendation generation system 220 may include programs configured to retrieve, store, and/or analyze properties of data models and datasets. For example, recommendation generation system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The recommendation generation system 220 may include algorithms to determine a data type, key-value pairs, row-column data structure, statistical distributions of information such as keys or values, or other property of a data schema may be configured to return a statistical profile of a dataset (e.g., using a data-profiling model). The recommendation generation system 220 may be configured to implement univariate and multivariate statistical methods. The recommendation generation system 220 may include a regression model, a Bayesian model, a statistical model, a linear discriminant analysis model, or other classification model configured to determine one or more descriptive metrics of a dataset. For example, recommendation generation system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The recommendation generation system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, recommendation generation system 220 may be configured to generate a similarity metric representing a measure of similarity between data in a dataset. A similarity metric may be based on a correlation, covariance matrix, a variance, a frequency of overlapping values, or other measure of statistical similarity.

The recommendation generation system 220 may be configured to generate a similarity metric based on data model output, including data model output representing a property of the data model. For example, recommendation generation system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The recommendation generation system 220 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The recommendation generation system 220 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, recommendation generation system 220 is configured to generate and/or train a classification model to classify a dataset, consistent with disclosed embodiments.

The recommendation generation system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the asset detection system may analyze information applying machine-learning methods.

While the recommendation generation system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the recommendation generation system 220 may include a greater or lesser number of components than those illustrated.

FIG. 3 is a block diagram of an example system that may be used to view and interact with digital image analysis system 308, according to an example implementation of the disclosed technology. The components and arrangements shown in FIG. 3 are not intended to limit the disclosed embodiments as the components used to implement the disclosed processes and features may vary. As shown, digital image analysis system 308 may interact with a user device 302 via a network 306. In certain example implementations, the digital image analysis system 308 may include a local network 312, a recommendation generation system 220, a web server 310, and a database 316.

In some embodiments, a respective user may operate the user device 302. The user device 302 can include one or more of a mobile device, smart phone, general purpose computer, tablet computer, laptop computer, telephone, public switched telephone network (PSTN) landline, smart wearable device, voice command device, AR device, other mobile computing device, or any other device capable of communicating with the network 306 and ultimately communicating with one or more components of the digital image analysis system 308. In some embodiments, the user device 302 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the digital image analysis system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The recommendation generation system 220 may include programs (scripts, functions, algorithms) to configure data for visualizations and provide visualizations of datasets and data models on the user device 302. This may include programs to generate graphs and display graphs. The recommendation generation system 220 may include programs to generate histograms, scatter plots, time series, or the like on the user device 302. The recommendation generation system 220 may also be configured to display properties of data models and data model training results including, for example, architecture, loss functions, cross entropy, activation function values, embedding layer structure and/or outputs, convolution results, node outputs, or the like on the user device 302.

The network 306 may be of any suitable type, including individual connections via the internet such as cellular or WiFi networks. In some embodiments, the network 306 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The digital image analysis system 308 may be associated with and optionally controlled by one or more entities such as a business, corporation, individual, partnership, or any other entity that provides one or more of goods, services, and consultations to individuals such as customers. In some embodiments, the digital image analysis system 308 may be controlled by a third party on behalf of another business, corporation, individual, partnership. The digital image analysis system 308 may include one or more servers and computer systems for performing one or more functions associated with products and/or services that the organization provides.

Web server 310 may include a computer system configured to generate and provide one or more websites accessible to customers, as well as any other individuals involved in accessing digital image analysis system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that are authenticated by the recommendation generation system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi, Bluetooth™, Ethernet, and other suitable network connections that enable components of the digital image analysis system 308 to interact with one another and to connect to the network 306 for interacting with components in the system 300 environment. In some embodiments, the local network 312 may include an interface for communicating with or linking to the network 306. In other embodiments, certain components of the digital image analysis system 308 may communicate via the network 306, without a separate local network 306.

The digital image analysis system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access digital image analysis system 308 using the cloud computing environment. User device 302 may be able to access digital image analysis system 308 using specialized software. The cloud computing environment may eliminate the need to install specialized software on user device 302.

In accordance with certain example implementations of the disclosed technology, the digital image analysis system 308 may include one or more computer systems configured to compile data from a plurality of sources the recommendation generation system 220, web server 310, and/or the database 316. The recommendation generation system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a user may have previously provided an organization with access to photos the user took on past trips. The user may have provided the organization with rights to access the photos via, e.g., local storage, cloud storage, and/or the user's social media account(s). A system, e.g., owned and/or operated by the organization, may be configured to receive the photos, and identify, using computer vision technology, various features in the photos indicative of travel. For example, the computer vision algorithms may be configured to identify landscapes, objects (e.g., a boat, food, etc.), people, animals, buildings, etc. The system may then train an MLM to input the various identified features from the photos, and generate one or more recommendations of trip destinations that the user may likely be interested in taking. The MLM may utilize FER technology to identify facial expressions of people in the photos to determine peoples' internal emotions or sentiments from their facial expressions. Utilizing FER technology may enable the MLM to increase its accuracy in generating recommendations fully tailored to the user and/or the user's travel companions (e.g., family, friends, etc.).

In some embodiments, the system may further enhance such trip recommendations by receiving transaction data associated with the user, and inputting the transaction data into the MLM, in addition to the image data. The MLM may be trained to evaluate travel-related features from the transaction data, such as dates, times, transaction amounts, merchant identifiers (e.g., a name of a restaurant), activity purchases (e.g., museum tickets, excursion reservations, etc.), and the like, to further increase the accuracy of the model's generated recommendations.

The system may provide such trip recommendations to the user, for example, via email, SMS message, push notification, etc. The system may then be configured to receive additional image and/or text data such that the system may determine whether it appears the user actually took the trip that the system recommended to him/her. Based on such feedback, the system may be configured to continuously train or update the MLM, and/or the threshold on which each trip recommendation may be based for determining whether the user is likely to be interested in taking such a trip.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive transaction data and image data associated with a user; identify, from the transaction data, one or more first travel features; identify, from the image data via computer vision, one or more second travel features; train a machine learning model (MLM) to generate one or more trip recommendations for the user based on the one or more first travel features and the one or more second travel features; determine, via the trained MLM, whether at least a first trip recommendation of the one or more trip recommendations exceeds a predetermined threshold indicating a likelihood the user will be interested in the first trip recommendation; and responsive to determining the first trip recommendation exceeds the predetermined threshold, provide the first trip recommendation to the user.

Clause 2: The system of clause 1, wherein the one or more first travel features comprise one or more of a merchant identifier, a location, a date, a transaction amount, a reservation booking, rental information, insurance information, or combinations thereof.

Clause 3: The system of clause 1, wherein the one or more second travel features comprise one or more of a location, an object, a building, a landscape, a person, an animal, a frequency of an image, a size of an image, a scale of an image, or combinations thereof.

Clause 4: The system of clause 1, wherein the MLM is configured to utilize facial emotion recognition (FER) technology.

Clause 5: The system of clause 4, wherein training the MLM to generate the one or more trip recommendations for the user is further based on the FER technology.

Clause 6: The system of clause 1, wherein the image data is stored locally and/or via cloud-based storage.

Clause 7: The system of clause 1, wherein the image data is stored via a social media account associated with the user.

Clause 8: The system of clause 7, wherein training the MLM to generate the one or more trip recommendations for the user is further based on social activity associated with the social media account, the social activity corresponding to the image data.

Clause 9: A system comprising: one or more processors; and a memory in communication with the one or more processors and storing instructions that, when executed by the one or more processors, are configured to cause the system to: receive image data associated with a user; identify, from the image data via computer vision, one or more travel features; train a machine learning model (MLM) to generate one or more trip recommendations for the user based on the one or more travel features and using a facial emotion recognition (FER) technology; determine, via the trained MLM, whether at least a first trip recommendation of the one or more trip recommendations exceeds a predetermined threshold indicating a likelihood the user will be interested in the first trip recommendation; and responsive to determining the first trip recommendation exceeds the predetermined threshold, provide the first trip recommendation to the user.

Clause 10: The system of clause 9, wherein the one or more travel features comprise one or more of a location, an object, a building, a landscape, a person, an animal, a frequency of an image, a size of an image, a scale of an image, or combinations thereof.

Clause 11: The system of clause 9, wherein the image data is stored locally and/or via cloud-based storage.

Clause 12: The system of clause 9, wherein the image data is stored via a social media account associated with the user.

Clause 13: The system of clause 12, wherein training the MLM to generate the one or more trip recommendations for the user is further based on social activity associated with the social media account, the social activity corresponding to the image data.

Clause 14: A system comprising: one or more processors; and a memory in communication with the one or more processors and storing instructions that, when executed by the one or more processors, are configured to cause the system to: receive transaction data and image data associated with a user; receive image data associated with a user; identify, from the image data via computer vision, one or more travel features; train a machine learning model (MLM) to generate one or more trip recommendations for the user based on the one or more travel features; determine, via the trained MLM, whether at least a first trip recommendation of the one or more trip recommendations exceeds a predetermined threshold indicating a likelihood the user will be interested in the first trip recommendation; and responsive to determining the first trip recommendation exceeds the predetermined threshold, provide the first trip recommendation to the user.

Clause 15: The system of clause 14, wherein the one or more travel features comprise one or more of a location, an object, a building, a landscape, a person, an animal, a frequency of an image, a size of an image, a scale of an image, or combinations thereof.

Clause 16: The system of clause 14, wherein the MLM is configured to utilize facial emotion recognition (FER) technology.

Clause 17: The system of clause 16, wherein training the MLM to generate the one or more trip recommendations for the user is further based on the FER technology.

Clause 18: The system of clause 14, wherein the image data is stored locally and/or via cloud-based storage.

Clause 19: The system of clause 14, wherein the image data is stored via a social media account associated with the user.

Clause 20: The system of clause 19, wherein training the MLM to generate the one or more trip recommendations for the user is further based on social activity associated with the social media account, the social activity corresponding to the image data.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive transaction data and image data associated with a user;
identify, from the transaction data, one or more first travel features;
identify, from the image data via computer vision, one or more second travel features;
train a machine learning model (MLM) to generate one or more trip recommendations for the user based on the one or more first travel features and the one or more second travel features;
determine, via the trained MLM, whether at least a first trip recommendation of the one or more trip recommendations exceeds a predetermined threshold indicating a likelihood the user will be interested in the first trip recommendation; and
responsive to determining the first trip recommendation exceeds the predetermined threshold, provide the first trip recommendation to the user.

2. The system of claim 1, wherein the one or more first travel features comprise one or more of a merchant identifier, a location, a date, a transaction amount, a reservation booking, rental information, insurance information, or combinations thereof.

3. The system of claim 1, wherein the one or more second travel features comprise one or more of a location, an object, a building, a landscape, a person, an animal, a frequency of an image, a size of an image, a scale of an image, or combinations thereof.

4. The system of claim 1, wherein the MLM is configured to utilize facial emotion recognition (FER) technology.

5. The system of claim 4, wherein training the MLM to generate the one or more trip recommendations for the user is further based on the FER technology.

6. The system of claim 1, wherein the image data is stored locally and/or via cloud-based storage.

7. The system of claim 1, wherein the image data is stored via a social media account associated with the user.

8. The system of claim 7, wherein training the MLM to generate the one or more trip recommendations for the user is further based on social activity associated with the social media account, the social activity corresponding to the image data.

9. A system comprising:
one or more processors; and
a memory in communication with the one or more processors and storing instructions that, when executed by the one or more processors, are configured to cause the system to:
receive image data associated with a user;
identify, from the image data via computer vision, one or more travel features;
train a machine learning model (MLM) to generate one or more trip recommendations for the user based on the one or more travel features and using a facial emotion recognition (FER) technology;
determine, via the trained MLM, whether at least a first trip recommendation of the one or more trip recommendations exceeds a predetermined threshold indicating a likelihood the user will be interested in the first trip recommendation; and
responsive to determining the first trip recommendation exceeds the predetermined threshold, provide the first trip recommendation to the user.

10. The system of claim 9, wherein the one or more travel features comprise one or more of a location, an object, a building, a landscape, a person, an animal, a frequency of an image, a size of an image, a scale of an image, or combinations thereof.

11. The system of claim 9, wherein the image data is stored locally and/or via cloud-based storage.

12. The system of claim 9, wherein the image data is stored via a social media account associated with the user.

13. The system of claim 12, wherein training the MLM to generate the one or more trip recommendations for the user is further based on social activity associated with the social media account, the social activity corresponding to the image data.

14. A system comprising:
one or more processors; and
a memory in communication with the one or more processors and storing instructions that, when executed by the one or more processors, are configured to cause the system to: receive transaction data and image data associated with a user;
receive image data associated with a user;
identify, from the image data via computer vision, one or more travel features;
train a machine learning model (MLM) to generate one or more trip recommendations for the user based on the one or more travel features;
determine, via the trained MLM, whether at least a first trip recommendation of the one or more trip recommendations exceeds a predetermined threshold indicating a likelihood the user will be interested in the first trip recommendation; and
responsive to determining the first trip recommendation exceeds the predetermined threshold, provide the first trip recommendation to the user.

15. The system of claim 14, wherein the one or more travel features comprise one or more of a location, an object, a building, a landscape, a person, an animal, a frequency of an image, a size of an image, a scale of an image, or combinations thereof.

16. The system of claim 14, wherein the MLM is configured to utilize facial emotion recognition (FER) technology.

17. The system of claim 16, wherein training the MLM to generate the one or more trip recommendations for the user is further based on the FER technology.

18. The system of claim 14, wherein the image data is stored locally and/or via cloud-based storage.

19. The system of claim 14, wherein the image data is stored via a social media account associated with the user.

20. The system of claim 19, wherein training the MLM to generate the one or more trip recommendations for the user is further based on social activity associated with the social media account, the social activity corresponding to the image data.
